(19) United States
(12) Patent Application Publication
(10) Pub. No.: US 2024/0264849 A1
(43) Pub. Date: Aug. 8, 2024

(54) Computer System User Interface With Quick Note Management

(71) Applicant: Google LLC, Mountain View, CA (US)

(72) Inventors: Alexandra Newhall Hill Olds, London (GB); Gabrielle Zadina, San Francisco, CA (US); Kejia Shao, Santa Clara, CA (US); Ajinkya Shirish Barve, Sunnyvale, CA (US); David Michael Black, Westlake Village, CA (US)

(73) Assignee: Google LLC, Mountain View, CA (US)

(21) Appl. No.: 18/105,294

(22) Filed: Feb. 3, 2023

(51) Int. Cl. G06F 9/451; G06F 3/04817; G06F 3/0482; G06F 3/0484; G06F 40/134; G06F 40/166

(52) U.S. Cl. CPC G06F 9/451; G06F 3/04817; G06F 3/0482; G06F 3/0484; G06F 40/134; G06F 40/166

(57) ABSTRACT

The technology provides a holistic approach to note-taking on client computing devices. An embedded app is integrated with an operating system-level user interface of a client device. The approach leverages system UI-level access to user data, supporting functionality including providing context for notes. This may include tagging a current context in a note, such as to indicate what the user was doing when taking the note and/or other information relating to how the note was triggered. Context can provide suggestions associated with a task when a user is interacting with a particular app or other program. The technology enables users to take notes quickly within their current task flow, via a system level tool. It offers users the opportunity to quickly jot down a thought and process it at a later time, while offering operating system-level easy access and also capturing the context from interactions that inspire the note.

### BACKGROUND

It can be helpful for a user to take electronic notes on their computer, mobile phone or other client device. This may be done using a dedicated app, or as a comment-type feature within a word processing program, a presentation program, or the like. However, it may be challenging for a user to manage the notes they take. In addition, notes taken in dedicated apps or as comments in a program can fail to provide useful context because they are siloed within their respective app or program.

### BRIEF SUMMARY

The technology involves a holistic approach to electronic note-taking on client devices. Note-taking may be done via an embedded app integrated with an operating system-level user interface of a client device—the system UI. This user interface may support existing apps or other programs that may or may not have a note-taking feature. Via this integration, the operating system is able to bridge the access to user data at the system UI level, and to support functionality including surfacing and supporting context for notes. This may be done across multiple apps or other programs, depending on user interaction with the client device and the context information.

According to one aspect, a computer-implemented method comprises: receiving, by one or more processors of a client device, an indication from a user of the client device to create a note; receiving, by the one or more processors via a system-level user interface module, user-generated note information; identifying, by the one or more processors via the system-level user interface module, one or more actions or events that occurred on the client device when the indication to create the note was received; generating, by the one or more processors via the system-level user interface module, one or more context suggestions for the note, the one context suggestions being based on the one or more actions or events; creating, by the one or more processors via the system-level user interface module, the note including the user-generated note information and at least a given one of the one or more context suggestions; and storing the note in memory associated with the client device.

In one example, the method further comprises the system-level user interface module presenting a visualization to the user with the generated one or more context suggestions. Alternatively or additionally, the indication to create the note is received based on selection of an icon presented in a user interface displayed on a display screen of the client device. Alternatively or additionally, generating the one or more context suggestions for the note includes generating a link to information about a meeting or an event that was occurring when the indication to create the note was received.

Alternatively or additionally to the above examples, generating the one or more context suggestions for the note may include generating contextual information about an action taken by the user within a predetermined amount of time prior to receiving the indication to create the note. The action taken may comprise triggering the note while playing media content.

Alternatively or additionally to the above examples, the one or more actions or events may include determining that the user's focus has transferred to the note from an application or a webpage. Alternatively or additionally to the above examples, the method may further comprise presenting a set of note-taking options to the user.

Alternatively or additionally to the above examples, the method may further comprise: upon receiving the indication, gathering by the one or more processors via the system-level user interface module, information about active applications or windows on the client device; wherein generating the one or more context suggestions is further based on the information about active applications or windows on the client device. Here, the method may further comprise creating bookmarks regarding a status of the applications or windows that are open. Alternatively or additionally to the above examples, storing the note in memory may comprise storing in memory corresponding to the system-level user interface module.

According to another aspect, a computer-implemented method comprises: receiving, by one or more processors of a client device, an indication to access a note, the note including user-generated note information and at least one context suggestion, in which the at least one context suggestion is based on one or more actions or events that occurred on the client device prior to creation of the note; retrieving, by the one or more processors via a system-level user interface module, the note from memory; identifying, by the one or more processors, whether to present the note via a note-taking application that is integrated as part of a system-level user interface of the client device, or another application executable by the client device; and generating by the one or more processors via the system-level user interface module, a graphical representation of the note including the user-generated note information and the at least one context suggestion, the graphical representation being configured for presentation to a user of the client device.

In one example, upon identification for presenting the note via the other application, the method includes sending note information including information about the at least one context suggestion to the other application. In another example, upon identification for presenting the note via the other application, the method includes transmitting note information including information about the at least one context suggestion to another client device associated with the user of the client device.

Alternatively or additionally to the above examples, the method may further comprise: upon generating the graphical representation, receiving input for selection of the at least one context suggestion from the user of the client device; accessing, by the one or more processors, information corresponding to the selection of the at least one context suggestion; and presenting the information corresponding to the selection of the at least one context suggestion to the user.

According to another aspect, a computing device is provided that comprises: memory configured to store system user interface information; and one or more processors operatively coupled to the memory. The one or more processors are configured to: receive an indication from a user of the computing device to create a note; obtain, via a system-level user interface module of the computing device, user-generated note information; identify, via the system-level user interface module, one or more actions or events that occurred on the computing device when the indication to create the note was received; generate, via the system-level user interface module, one or more context suggestions for the note, the one context suggestions being based on the one or more actions or events; create, via the system-level user interface module, the note including the user-generated note information and at least a given one of the one or more context suggestions; and store the note in the memory.

In one example, the one or more processors are further configured, via the system-level user interface module, to either present a visualization to the user with the generated one or more context suggestions, or present a set of note-taking options to the user. Alternatively or additionally, generation of the one or more context suggestions for the note includes at least one of: generation of a link to information about a meeting or an event that was occurring when the indication to create the note was received; or generation of contextual information about an action taken by the user within a predetermined amount of time prior to receiving the indication to create the note.

And according to a further aspect, a computing device is provided that comprises: memory configured to store system user interface information; and one or more processors operatively coupled to the memory. Here, the one or more processors are configured to: receive an indication to access a note, the note including user-generated note information and at least one context suggestion, in which the at least one context suggestion is based on one or more actions or events that occurred on the computing device prior to creation of the note; retrieve, via a system-level user interface module of the computing device, the note from the memory; identify whether to present the note via a note-taking application that is integrated as part of a system-level user interface of the computing device, or another application executable by the computing device; and generate, via the system-level user interface module, a graphical representation of the note including the user-generated note information and the at least one context suggestion, the graphical representation being configured for presentation to a user of the client device.

### BRIEF DESCRIPTION OF THE DRAWINGS

FIGS. 1A-C illustrate user interface examples in accordance with aspects of the technology.

FIG. 2 illustrates an example client device for use in accordance with aspects of the technology.

FIGS. 3A-C illustrate user interface features in accordance with aspects of the technology.

FIGS. 4A-D illustrate example windows for different note taking options in accordance with aspects of the technology.

FIGS. 5A-B illustrate note storage examples in accordance with aspects of the technology.

FIGS. 6A-D illustrate context suggestion examples in accordance with aspects of the technology.

FIG. 7 illustrates a sharing example in accordance with aspects of the technology.

FIGS. 8A-B illustrate a system for use with aspects of the technology.

FIGS. 9A-B illustrate example methods in accordance with aspects of the technology.

### DETAILED DESCRIPTION

The electronic note-taking technology described herein leverages an integration between a note taking app and the system level surfaces (e.g., login screen, shelf or system tray, etc.) and data with an operating system-level user interface (system UI) to provide context to the user, and to leverage that context to enrich the user experience. This includes tagging a current context in a note, such as to indicate what the user was doing when taking the note and/or other information relating to how the note was triggered. Context can be employed to provide suggestions associated with a primary task when a user is interacting with a particular app or other program. This can include referencing a recent app or doc, providing a link to content via a browser, etc. The system-level integration also avoids issues with siloed notes tied to individual applications, and allows for sharing context or other information across apps or even across client devices.

Thus, the solution described herein enable users to take short notes quickly within their current task flow, via a system level tool. This approach is designed for note taking as a secondary task and need not replace a primary note taking. Rather, the technology offers users the opportunity to quickly jot down a thought and process it at a later time, while offering operating system-level easy access and also capturing the context from interactions that inspire the note. Aside from enhancements that are beneficial to the user, a technical benefit to the computing system involves effective management of note-related content that can be shared across various types of apps on a client device or synchronized across different devices associated with a user (e.g., a laptop, a tablet and a smartwatch), such as via a cloud-based syncing approach.

### Example System

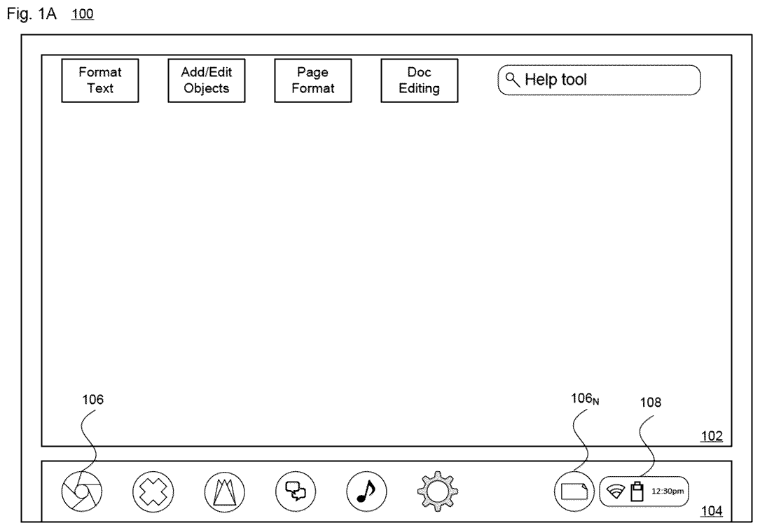

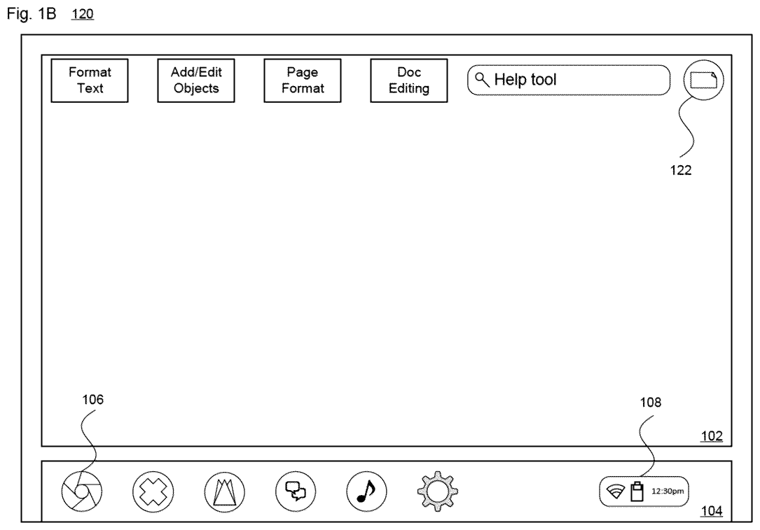

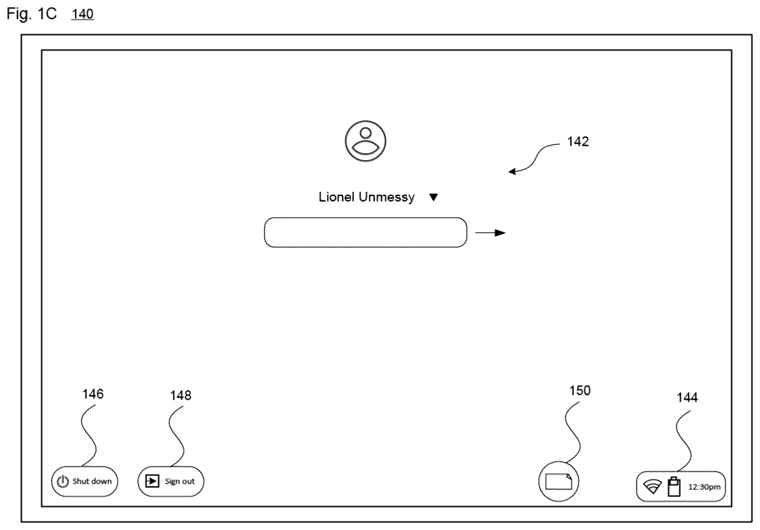

FIG. 1A illustrates an example 100 of a user interface for a client device, such as a laptop or tablet computer, although the technology may be used with other types of client devices. As shown, the displayable area of the user interface includes a first section 102 that may be associated with an app or other program, and a second section 104. In this example, as shown in the first section 102 the program may be a word processor that provides options for formatting text, adding or editing objects, performing page formatting or document editing, etc.

The second section 104 of the user interface may be a shelf or system tray, which in this example is not part of or associated with the program. Here, as shown there are a number of icons 106 in the shelf or tray, along with a subsection 108 indicating the status of various parts of the client device (e.g., WiFi signal strength and battery level) as well as the local time. In this example, one of the icons 106_{N} is for a note-taking app that is integrated with or otherwise associated with the system's user interface. The user may launch the note-taking app via selection of the icon 106_{N}. According to one aspect, the icon 106_{N} is not an app icon, but rather a pod icon that is associated with system level functionality. While app icons are entry points to specific apps run on the client device, pod icons may be considered as shortcuts to secondary tasks or tools associated with the system itself.

While shown in the shelf or tray, the note-taking icon or other indicia may be presented elsewhere on the display of the client device. For instance, an icon may be incorporated into the app in the first section 102. An example 120 of this is illustrated in FIG. 1B, with embedded icon 122 being located in the first section 102, where it is associated with the word processor app of this example. In another example 140 illustrated in FIG. 1C, note-taking may be initiated from the lock screen. Here, in addition to a login section 142 and other icons, e.g., for status indicators (144), shutting down or restarting the client device (146) and/or signing out (148), a note-taking icon or other indicia 150 may also be presented.

Because the note-taking feature may be integrated or otherwise associated with the system UI, user interface data may be maintained or otherwise managed by a system UI module. This can enable latency optimization for efficient loading times for the note-taking feature. It also supports embedding the feature in one or more specific locations of the system UI, to provide the quickest access possible. Regarding the technical benefit of load time optimization, the system is able to load the note taking app in the background so that it is already in a ready state by the time the user signals their intent to take notes. This allows the system to show the apps embedded in system UI with very low latency once the user has signaled intent.

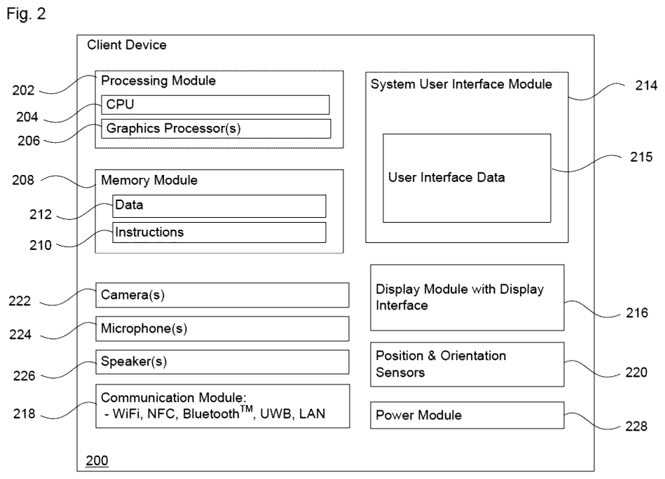

An example client device arrangement 200 is shown in FIG. 2. As shown, the client device includes a processing module 202 having one or more computer processors such as a central processing unit 204 and/or graphics processors 206, as well as memory module 208 configured to store instructions 210 and data 212. The processors may or may not operate in parallel, and may include ASICs, controllers and other types of hardware circuitry. The processors are configured to receive information from a user through a system user interface module 214, and to present information to the user on a display device of the display module 216 via the user interface module. For instance, during different modes at different times or in different situations, the user interface module may cause the display device to present a screen saver, a login screen, as well as apps and other features. The display module 216 has a display interface and may be configured as a touchscreen that enables user input via a stylus or other tool, or by the user physically touching the screen.

System user interface module 214 is configured to receive user input and store user interface data 215. User interface module 214 may receive commands from a user via user inputs and convert them for submission to a given processor. The user interface module may link to a web browser (not shown). The user inputs may include a touchscreen as noted above, in addition to or alternatively from a keyboard, keypad, mousepad and/or touchpad, microphone, gesture-based input or other types of input devices. The keyboard, keypad, mousepad and/or touchpad may be part of or connectable to the base via a cable or other wired connection, or may physically separate from the integrated client device and configured to connect via one or more wireless connections such as Bluetooth™, WiFi, ultra-wideband (UWB), infrared, etc. The user interface module 214 can be operatively connected to the display module 216.

The user interface data may include information associated with a note-taking app. By way of example, such information may indicate not only where and how to present an indicia to launch/access the note-taking app, but also to which programs that app is associated (e.g., a word processing program, a presentation program, a spreadsheet program, a web browser, a messaging app, etc.). The user interface data may also include context information for the notes made by the user via the note-taking app.

The display module 216 may comprise circuitry for driving the display device to present graphical and other information to the user. In other words, the display device is configured to present visual content. Actuators to provide tactile feedback or other information to the user may be incorporated into the touchscreen of the display module (not shown). The graphical information may be generated by the graphics processor(s) 206, while CPU 204 manages overall operation of the integrated client device 200. By way of example only, the graphical information may display responses to user queries on the display module 216. For instance, the processing module may run a browser application or other service using instructions and data stored in memory module 208, and present information associated with the browser application or other service to the user via the display module 216. The memory module may include a database or other storage for browser information, location information, etc. In one scenario, the user interface data 215 may be part of the data 212 stored in memory module 208.

Memory module 208 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. Alternatively, the memory module 208 may also include removable media (e.g., DVD, CD-ROM or USB thumb drive). One or more regions of the memory module 208 may be write-capable while other regions may comprise read-only (or otherwise write-protected) memories. In one implementation, a computer program product is tangibly embodied in an information carrier. Although FIG. 2 functionally illustrates the processor(s), memory module, and other elements of integrated client device as being within the same overall block, such components may or may not be stored within the same physical housing. For example, some or all of the instructions and data may be stored on an information carrier that is a removable storage medium connectable to the base or the display housing (e.g., optical drive, high-density tape drive or USB drive) and others stored within a read-only computer chip which is integrated into the base or the display housing.

The data 212 and/or 215 may be retrieved, stored or modified by the processors in accordance with the instructions 210. For instance, the data may be stored in computing device registers, in a relational database as a table having a plurality of different fields and records, XML documents or flat files. The data may also be formatted in any computing device-readable format.

The instructions 210 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 2, the client device 200 includes a communication module 218 for communicating with other devices and systems, including other client devices, servers and databases. The communication module 218 includes a wireless transceiver; alternatively, the module may alternatively or additionally include a wired transceiver. The client device 200 may communicate with other remote devices via the communication module 218 using various configurations and protocols, including short range communication protocols such as near-field communication (NFC), Bluetooth™, Bluetooth™ Low Energy (BLE), UWB or other ad-hoc networks, the Internet, intranets, virtual private networks, wide area networks, local networks, private networks using communication protocols proprietary to one or more companies, Ethernet, WiFi and HTTP, and combinations of the foregoing.

In addition, the example device as shown includes one or more position and orientation sensors 220. The position and orientation sensors 220 are configured to determine the position and orientation of one or more parts of the computing device 200, such as the display housing relative to the base. For example, these components may include a GPS receiver to estimate the integrated client device's latitude, longitude and/or altitude, as well as an accelerometer, gyroscope or another direction/speed detection device such as an inertial measurement unit (IMU) capable of determining the orientation of a display housing relative to a base of the device (as well as the rate of change of the positioning of the client device). The client device 200 may also include one or more camera(s) 222 for capturing still images and recording video streams such as an integrated webcam. The device may also include one or more microphones 224, speakers 226, as well as a power module 228.

### Example Operation

From a user perspective, note-taking via the app described herein can be a seamless experience. According to one aspect of the technology, such notes may be referred to as “quick notes” for the ease of creation and use. Regardless of whether a quick note is generated from the lock screen, the system tray or within a program (which may have its own dedicated note-taking feature), interaction with such notes may function the same. Thus, a consistent user interface can be presented even when using different types of apps (e.g., a word processing app, a presentation app, a web browser and a videoconferencing app) from different companies.

In addition to there being different ways to launch quick notes, there are different ways to capture such notes, as well as a variety of use cases. For instance, if the user wants to capture information immediately, he or she can invoke the quick note app from the lock screen, system tray or other shortcut. The user may want to make a note while interacting with a particular program, such as while browsing a website, watching a video, or flagging an action item during a meeting (e.g., during a videoconference). Or the user may want to take notes as part of their regular workflow using familiar tools. This can include using a stylus while in a tablet mode, a keyboard while in a desktop mode, or even using gestures during hands-free operation.

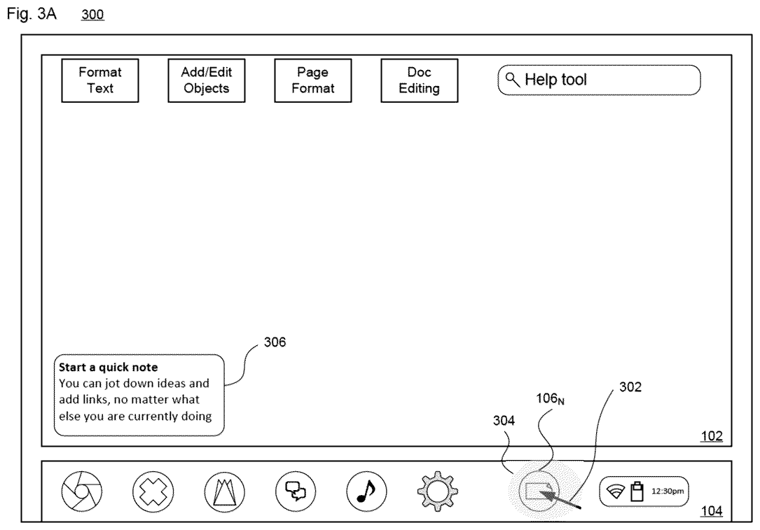

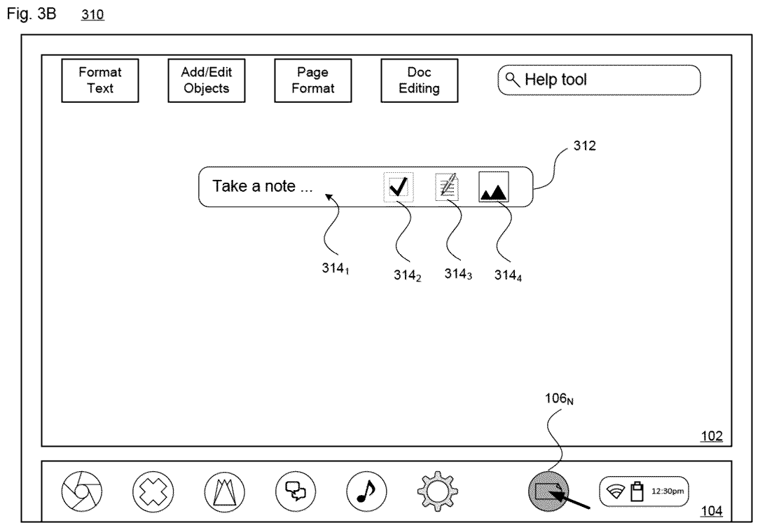

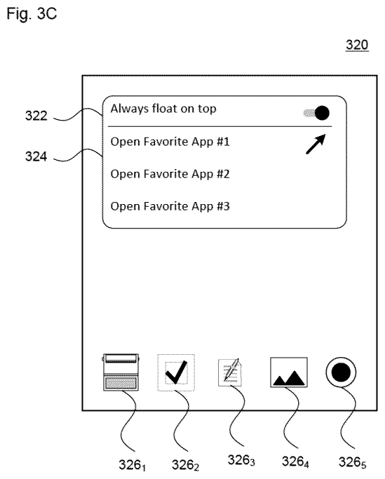

FIG. 3A illustrates one example 300, in which a user can hover over icon 106_{N}, for instance with an arrow icon 302 (e.g., using a mouse, stylus or hand gesture). Here, the hovering can be accentuated by shading 304. A result of the hovering may be pop-up 306, which includes information about the quick note feature. Selection of the icon 106_{N} would launch the quick note feature. Upon selection, the user may be presented with different options. For instance, as shown in example 310 of FIG. 3B, an option bar or other feature 312 may be presented on the display to show the user various note-taking options, e.g., typing into a field (3141) using checkboxes (3142), freehand writing (3143), inserting links (3144), etc. As shown in FIG. 3B, the icon 106_{N} is shaded to indicate selection. FIG. 3C illustrate a different interface 320, which includes different options including a selection to always float the quick note option bar on top of an app (322), a list of favorite apps (324) that can be opened while also creating a note associated with a selected app, as well as the type of note to create, such as one that is typed (3261), uses checkboxes (3262), is freehand (3263), has a link (3264) or is an audio note (3265).

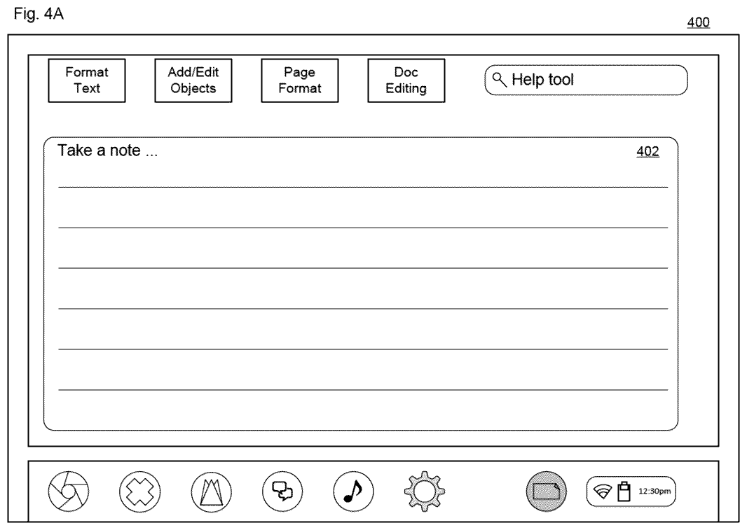

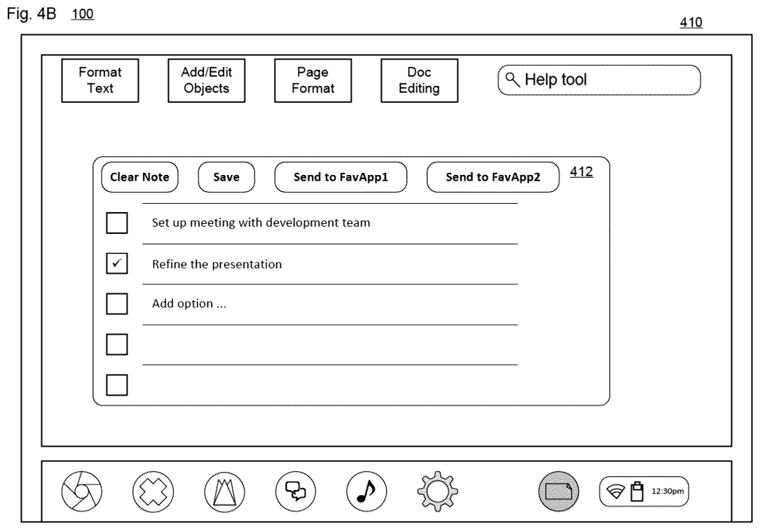

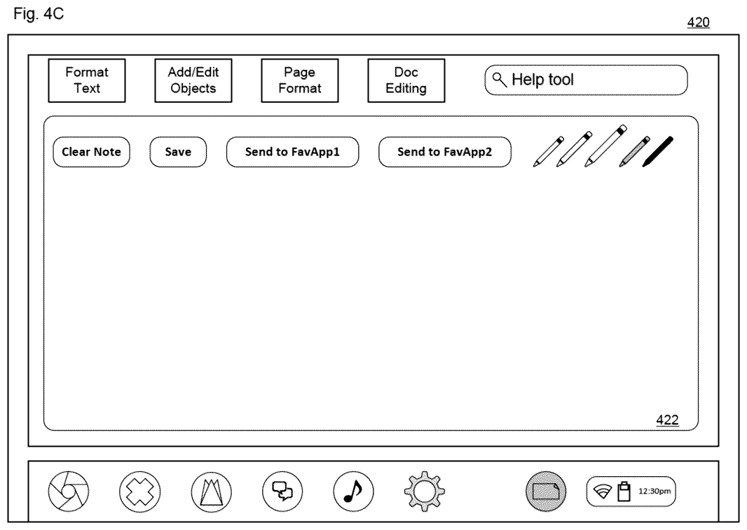

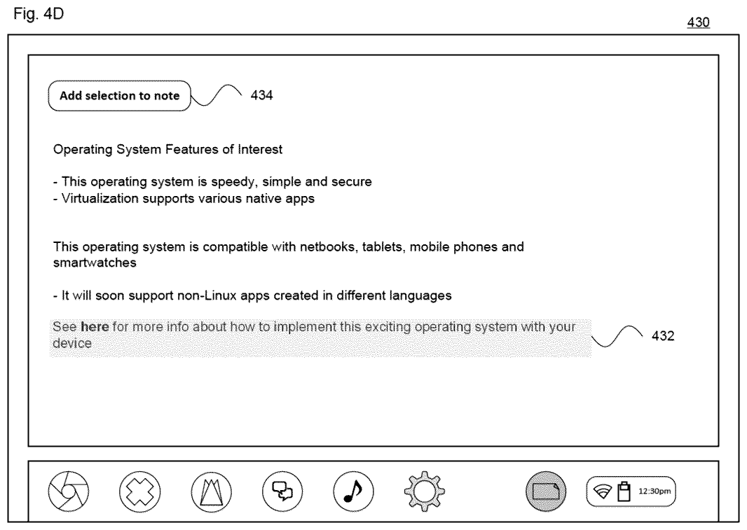

FIG. 4A illustrates an example 400 showing a typing window 402 for the user to input a note. FIG. 4B illustrates another example 410 showing a checkbox UI 412. As shown, the user can input different options, and the system may provide default options as well. Once one or more notes have been selected (e.g., with a checkmark), the user can save the quick note and/or send it to like with a particular app. FIG. 4C illustrates yet another example 420 for a freehand note, in which the freehand UI 422 includes options for clearing, saving and sending the note, as well as different pen sizes and colors. The windows in these examples may be presented as part of the system UI and not associated with a particular app that is open. These windows may alternatively be presented as an overlay to or within the UI of an app that the user is currently working in (e.g., a word processor, video call or web browser).

FIG. 4D illustrates an example 430 where a user may select content 432 within the UI (e.g., information that may be presented in a page of a web browser), such as text, a hyperlink, an icon, an image or a video, and add the selection to a note. Here, a button 434 (or a popup or other selector) can be presented to the user. If multiple notes exist, the interface may list all or a subset of notes to which the selection may be copied. Once the content is selected, presentation of that selection in a note may be formatted by the system UI according to the type of note. For instance, for a text entry note or freehand note, the content may be presented to appear the same way as the original (e.g., as a block of text that says “See here for more info about how to implement this exciting operating system with your device”). But for a checkbox-type note, the content may be sized to fix or otherwise truncated to fit next to a checkbox (e.g., “See here for more info . . . ”).

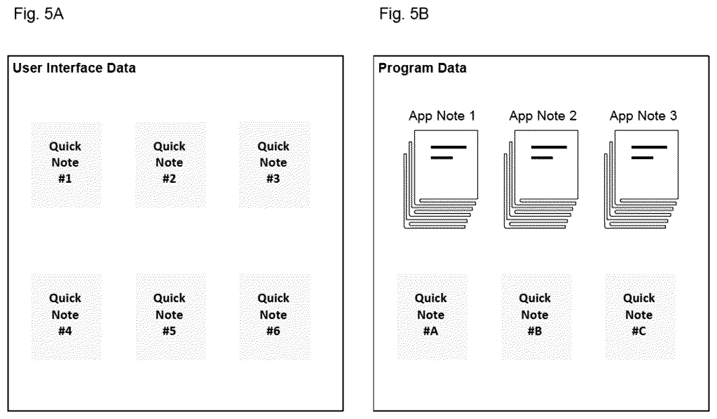

According to one aspect, the information for a quick note may be saved in different ways. This can include local saving, e.g., as user interface data associated with the system UI (e.g., system UI module 214 in FIG. 2). An example of this is shown in FIG. 5A, which illustrates a set of notes (e.g., notes 1-6) stored as user interface data such as with part of the system UI. Alternatively or additionally, a note may be saved to one or more selected apps on the client device. This may be suitable when such apps have their own respective note-taking features, which may be siloed. An example of this is shown in FIG. 5B, where the program data of a particular app includes a set of app notes (e.g., app notes 1-3) and a separate set of quick notes (e.g., notes A-C).

The quick notes may be stored using the same folder structure or other format that is used to store app-specific notes. There may be a flag or other identifier associated with each note to identify whether it is associated with a particular app, or is part of the system UI set of notes. A note may also be saved remotely, e.g., in cloud storage or a back-end service that supports one or more progress web apps. This may involve auto-syncing notes (e.g., every 10 minutes or some other timeframe). When saved in the cloud or as part of the system UI, quick notes may be readily accessed across different client devices.

In one scenario, for a given app, all app notes and quick notes may be accessible via the given app. However, app notes may or may not be accessible from the system UI. And if a quick note is opened from the system UI (e.g., from a system tray, shelf or other access point not in a given app), then the ability to edit that quick note may be automatically disabled from within the given app. This can prevent the unintended creation of multiple iterations of the same quick note.

### Context

The system provides the ability to tag the user's current context within the operating system. This provides the user the ability to elect to add a context chip (or other indicia) that references what they were doing while taking the note (or just before taking the note). Suggestions may come from the user's primary task at the moment, e.g., the most recent app that was used, document that was opened, or link that was accessed. Because this can be done with the note-taking app at the operating system (system UI) level, and not within a particular app, this can be a power tool that enables the system to surface context to the user regardless of what program they are currently using.

Context for notes has several interesting aspects, which include information input by the user when they create the note, as well as suggestions shown to the user when they retrieve or are otherwise presented with a stored note. This could include suggestions to view specific information in a doc (e.g., a line item in a spreadsheet) or on a website (e.g., the link in highlighted information 432 of FIG. 4D). The contextual information may depend on how the note was triggered (either created or retrieved), the app (if any) the person is using at the time, as well as other factors. Context can be employed to provide suggestions for information to consider (e.g., a webpage or video to view), as well as to remind the user of, e.g., an action or event relevant to the note.

The following are different examples of how context can be prompted by the system when a user creates a note. For instance, if a note is triggered during a calendared meeting (e.g., the user joined a video call or other meeting based on a pre-existing calendar event), then the system can automatically provide a context suggestion to the user to attach a link (or a link as a chip) to the note. This link may be to a recording of the meeting, notes about the meeting, or other information about the meeting. In another example, if the note is triggered during a meeting and the user's screen or a specific item from the user is being presented in the meeting, then the system can provide a context suggestion to attach a link to the presentation, a screenshot of the presentation, or the contents of the item being presented.

In another example, temporal interactions can provide a contextual signal. Thus, if a note is triggered within a certain amount of time (e.g., within 5-30 seconds) after taking a screenshot (or other action), the system could automatically provide a suggestion to add that screenshot (or information about the other action) to the note. Or if a screenshot (or other action) is taken when a note is open, the system can automatically provide a suggestion to add that screenshot and/or a link to the screenshot location to the note. Examples of other actions include browsing to a particular webpage, opening a document, looking up contact information (e.g., an email address or phone number), etc. The system UI may store a copy of the screenshot in the user interface data so that the information persists if the original version of the screenshot is deleted or not saved by the user. Thus, if a screenshot or other action is associated with a given note, then when that note is later opened information about the associated action is presented to the user. This may include presenting the screenshot (or document or contact information, etc.), or providing a link to access it. Alternatively, when user browses through one or more screenshots, if any is associated with a note then the system UI may indicate that there is a corresponding note.

In a further example, if a note is triggered and it is determined by the system that the user's focus is transferred from a website they had been viewing (e.g., by going to a different browser tab or switching to a different app), the system can automatically provide a suggestion to add a website link (or a link as a smart chip) to the note. In yet another example, if a note is open and the user copies something (e.g., select text, an image, a video link or a url), then the system can automatically provide a suggestion to add a copy of the item and/or a link to copy location into the note. An example of this is shown in FIG. 4D as discussed above.

In another example, if a note is triggered while a video (or audio) is being played, the system may automatically provide a suggestion to add a link to the video (or audio) at that specific timestamp. Here, if the note has been triggered or is already open, and then the user pauses playing of the content, then the system could suggest a link at the pause timestamp. And in a further example that is complementary to any of these scenarios, the system could provide the suggestion to add a date to the note. Alternatively or additionally, the user could be prompted to add an emoji, gif, sticker or other indicia to the note.

In one scenario, the context prompt could be via chip using an “@” mention of a person, date, calendar event, place, directions, link to another app or link to a particular file (in an app). Thus, if the user is on a conference call, the system may surface a prompt to add into the note with the name or email address of one or more participants on the call. Or a date chip may be surfaced, e.g., @tomorrow or @Thursday.

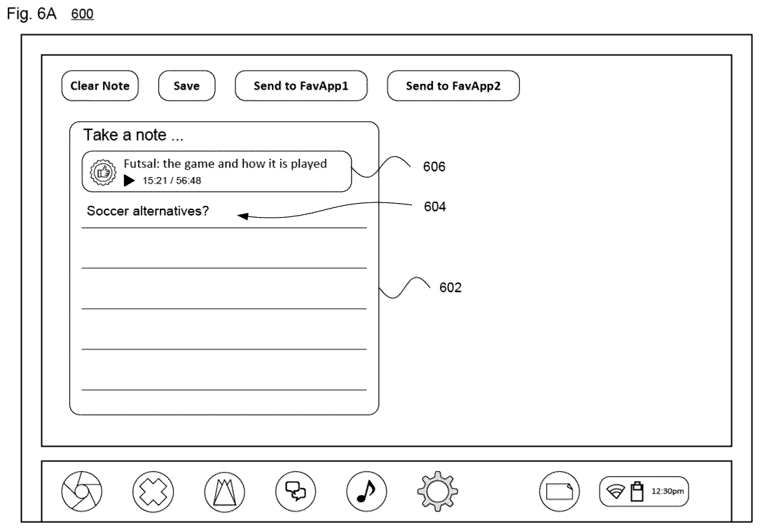

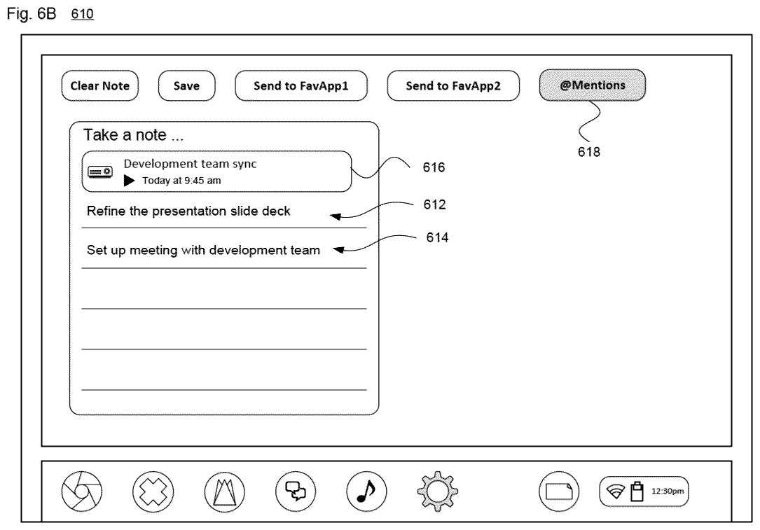

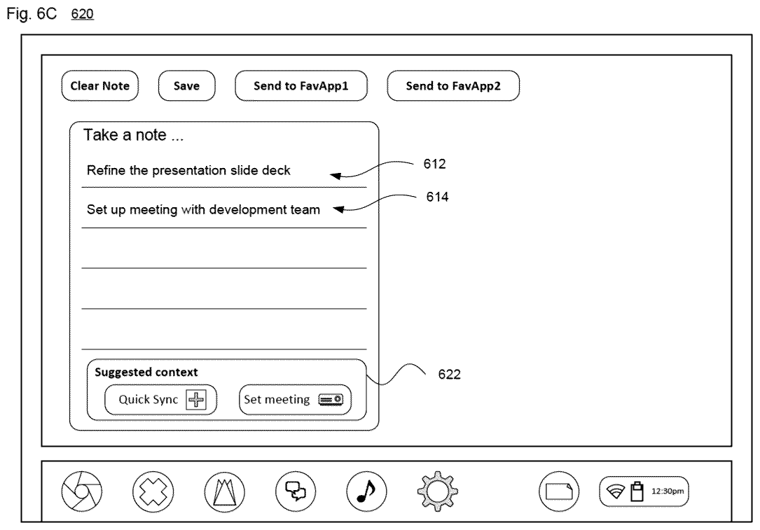

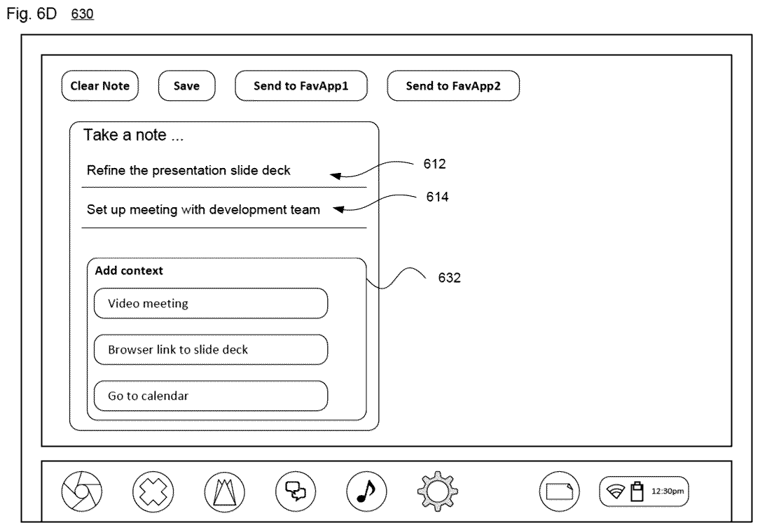

FIG. 6A illustrates an example 600 in which a note 602 has been opened. The user has input information 604 into the note, here “Soccer alternative?”. Assume that the user had been listening to a podcast or watching a video at the time the note 602 was opened. In this example, the system may either automatically populate a context suggestion 606 or the user may copy a link about that content into the note 602. This content (here “Futsal: the game and how it is played”) can be added with a timestamp associated with either when the playback was paused, when the note was launched, or when the link to the content was added to the note.

FIG. 6B illustrates another example 610 in which a note 612 has been opened. Here, the user has input a couple of pieces of information into the note. This includes a reminder to “Refine the presentation slide deck” 612, and a comment about a meeting, “Set up meeting with development team” 614. In this example, the system may either automatically create a context suggestion 616 for a meeting invite or the user may create the invite and paste a copy to meeting link in the note 612. In this example, an @mentions option 618 can be included in the note UI. By way of example, upon selection of @mentions, the user could be prompted by the UI to include members from the development team, to create a calendar invite, and/or to set up a video link.

FIG. 6C illustrates an example 620 in which the system UI, via the note-taking app, suggests a context to the user. Here, the user has entered the notes as discussed in FIG. 6B. In this case, the note-taking UI can present a popup or other visualization 622 for suggested context. This visualization could be populated with different suggestions based on the content of the notes (e.g., using keyword evaluation or other contextual analysis of the content) or by what the user was doing when the note was taken. As shown, that can include presenting options for a quick sync and/or meeting setup.

FIG. 6D illustrates another example 630 in which the system UI, via the note-taking app, suggests context options to the user. Here, the user has entered the notes as discussed in FIG. 6B. In this case, the note-taking UI can present a popup or other visualization 632 for suggested context. Similar to FIG. 6C, this visualization can present different suggestions based on the content of the notes (e.g., using keyword evaluation or other contextual analysis of the content). As shown, that can include presenting context options to remind the user to set up a video meeting, link to the current slide deck, or check their calendar to set up a meeting time to go over the slide deck.

These examples are not limiting, and the user may always be free to disregard, reject or otherwise dismiss a context suggestion. A given suggestion may also be time-constrained. For instance, if the user does nothing about the suggestion and ignores it for at least a threshold amount of time (e.g., 5-10 seconds or more or less), then the suggestion may be dismissed.

According to another aspect, context for a note may involve an action that the user may want to take. For example, the system may surface an action item to add to a task list or a calendar event if the user types into the note starting with a verb or a keyword, which may be part of a default list of words generated by the system or identified by the user. Or if the note indicates the need to schedule a meeting, the system may surface an action item to create a calendar event. And if the note indicates the need to send an email, the system may surface an action item to start an email (e.g., suggest launching an email app). These types of actions are non-limiting.

The user may also choose to create context and add it into a note even when not prompted by the system.

Once a note is created, the user may retrieve it by launching the note-taking app, whether that is from the system UI or within a particular app. For instance, the system UI may generate a graphical representation of the note including any user-generated note information and any context suggestions that are associated with the note. The graphical representation may be presented on the client device at which it was created, or another client device that has received the note. When input for selection of a context suggestion is received from the user, information corresponding to the selection is accessed by the system and information corresponding to that context suggestion is presented to the user. Thus, when the context suggestion corresponds to a video or music, the graphical representation may provide the user with the option of resuming playback of the video or music or otherwise launching that content (see, e.g., FIG. 6A). When the context suggestion corresponds to a meeting (see, e.g., FIGS. 6B-D), then a link to a calendar invite, meeting link, etc., may be provided. When the context suggestion corresponds to a presentation or other material (see, e.g., FIG. 6D), then a link to a slide deck for the presentation or to the other material may be provided.

When a note is open, the note-taking app allows the user to select, copy, paste and/or delete some or all of the content in the note, including context information. If the context information provides a link to content (e.g., a text file, music or a video), selection of a context chip or other indicia would bring the UI to that content (or otherwise open the content in the UI).

The user may create a new note from scratch, or from within another note. If this is done from an existing note, the system may automatically save the existing note and launch the new note. The interface may enable the user to name or rename a note, select where to save the note, or move the note, e.g., from the system UI to a specific app, or from a specific app to the system UI. If the client device is currently offline, the note is saved locally, and can be uploaded to a backend location of the user's choice when back online.

A note may be re-surfaced, e.g., opened by the user or opened by the system based on a triggering item or event associated with the contextual information in the note.

Sharing notes across apps on a client device may be done as follows. When a system UI-associated note is opened, the system is configured to suggests the context and surface the context to the user. For instance, when the user clicks to open a quick note, the system gathers information about what particular apps or windows are open on the client device. Bookmarks may be created for those items, that have some reference by which context can later be restored. The note information, including any relevant context information associated with the note, can then be cast (sent) to a particular app or destination, such as a spreadsheet, calendar or videoconference app. If the user accesses a web-based app (e.g., a progressive web app), the note information may be shared via a “service worker”, which is a virtual proxy between the client device side (e.g., a browser app) and the network.

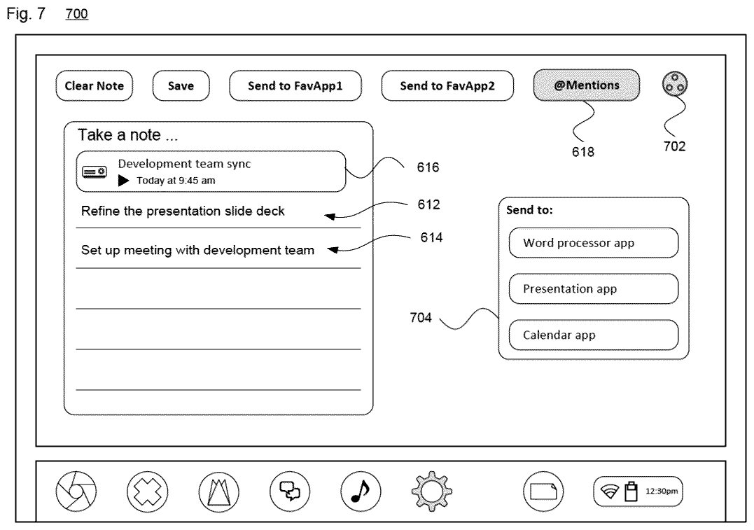

FIG. 7 illustrates a sharing example 700. As shown, the note-taking UI may include an icon or other indicia 702 to share the note. When selected, a popup or other visualization 704 is presented, identifying different options for apps to which the note may be shared. This can include local apps (e.g., the word processing app or the presentation app), as well as remote apps, e.g., a progressive web calendar app, where different users may be able to access different calendars. Selection of one or more of these options results in some or all of the note's contents (including context information) being shared with those programs. Thus, because the operating system has access to the browser, locally run programs, progressive web apps and access to everything on-screen, the note information managed via system UI can be selectively shared with different apps as warranted, including relevant context information that may be suitable for a particular app.

The user may have multiple applications/windows on screen at a time. In such situations, they may wish to associate all, none, or a subset of those with a given note. The system may enable the user to disambiguate which context(s) they are interested in, in other words to curate which, if any, contexts should be associated with the note.

Further to the descriptions above, a user may be provided with controls allowing the user to make an election as to both if and when systems, programs, or features described herein may enable collection of user information, including context information that may be associated with quick notes. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

### Example Network

While a system-UI focused note-taking app is resident on one user device, as discussed above the notes, including context information, may be shared among apps that may be locally resident on that user device, as well as apps that are maintained remotely. This can include progressive web apps that may be in the cloud or other remote service. It can also include apps stored on other client devices of a particular user (e.g., a laptop, tablet, mobile phone, smartwatch, etc.).

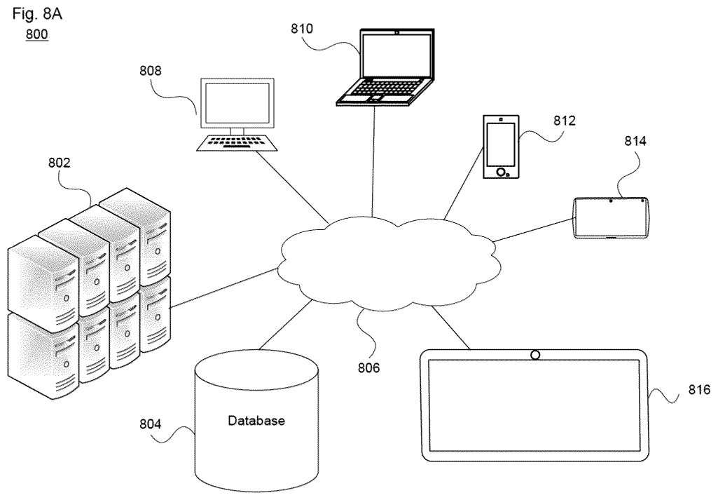

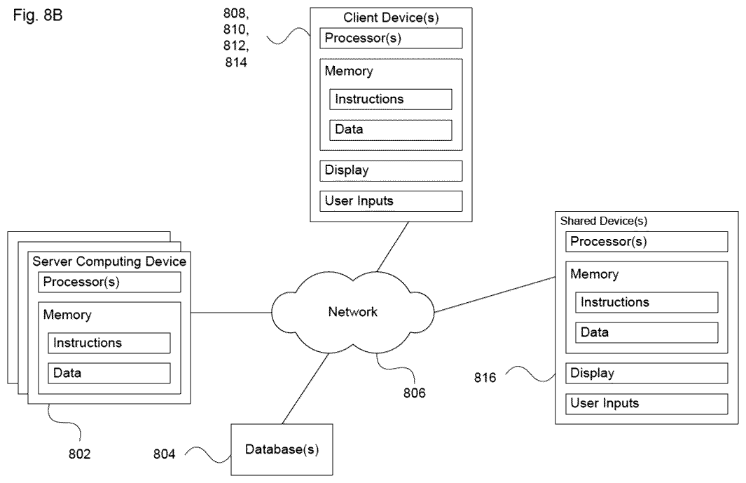

FIGS. 8A and 8B are pictorial and functional diagrams, respectively, of an example system 800 that includes a plurality of computing devices and databases connected via a network. For instance, computing device(s) 802 may be a cloud-based server system that provides or otherwise supports one or more cloud-based apps, games, or other programs. Database 804 may store app information, game data, user profile information, and/or other information. In one example, the database 804 may store note-based information (including context information) from a system UI-based note-taking app associated with a user's client device(s). The server system may access the databases via network 806. Client devices may include one or more of a desktop computer 808 or a laptop or tablet PC 810. Other client devices may include handheld devices including a personal communication device such as a mobile phone or PDA 812 or a tablet 814. Another example is a shared device 816, which may be a smart display or large monitor that can in a conference room, classroom or other collaborative setting.

In one example, computing device 802 may include one or more server computing devices having a plurality of computing devices, e.g., a load balanced server farm or cloud computing system, that exchange information with different nodes of a network for the purpose of receiving, processing, and transmitting the data to and from other computing devices. For instance, computing device 802 may include one or more server computing devices that are capable of communicating with any of the computing devices 808-816 via the network 806. This may be done as part of hosting one or more collaborative apps (e.g., a videoconferencing program, an interactive spreadsheet app or a multiplayer game) or services (e.g., a movie or podcast streaming service).

As shown in FIG. 8B, each of the computing devices 802 and 808-816 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 8B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 802. Accordingly, references to a processor or memory will be understood to include references to a collection of processors or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements, audibly and/or via haptic feedback). The user interface subsystem may include one or more user inputs (e.g., at least one front (user) facing camera, a mouse, keyboard, touchscreen and/or microphone) and one or more display devices that is operable to display information (e.g., text, imagery and/or other graphical elements). Other output devices, such as speaker(s) may also provide information to users.

The user-related computing devices (e.g., 808-816) may communicate with a back-end computing system (e.g., server 802) and/or each other via one or more networks, such as network 806. The network 806, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces. In some implementations, the user-related computing devices may also communicate with one another without also communicating with a back-end computing system. This may be done via network 806, or using one or more ad hoc and/or peer to peer communication links directly between the devices.

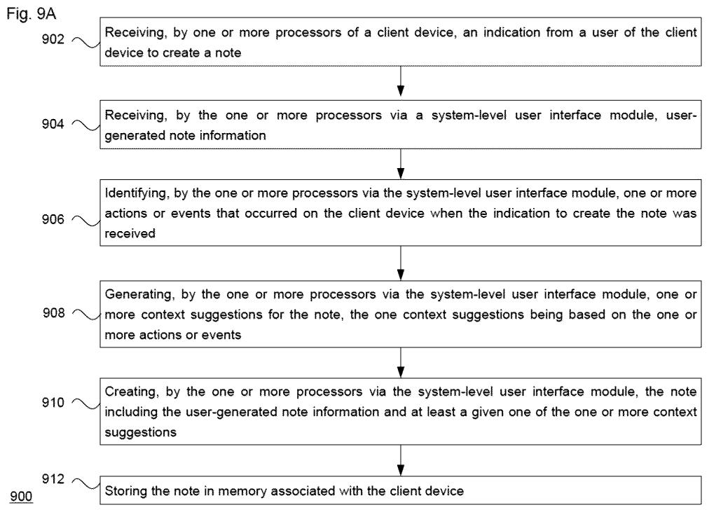

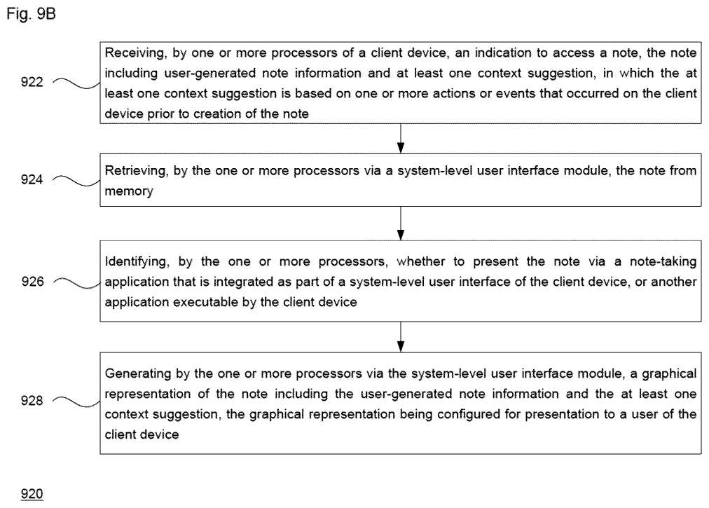

FIG. 9A illustrates an example method 900 according to aspects of the technology. At block 902, the method includes receiving, by one or more processors of a client device, an indication from a user of the client device to create a note. At block 904 the method includes receiving, by the one or more processors via a system-level user interface module, user-generated note information. Then at block 906, the method includes identifying, by the one or more processors via the system-level user interface module, one or more actions or events that occurred on the client device when the indication to create the note was received. At block 908 the method includes generating, by the one or more processors via the system-level user interface module, one or more context suggestions for the note, the one context suggestions being based on the one or more actions or events. Then at block 910 the method includes creating, by the one or more processors via the system-level user interface module, the note including the user-generated note information and at least a given one of the one or more context suggestions. And at block 912 the note is stored in memory associated with the client device.

FIG. 9B illustrates another example method 920 according to aspects of the technology. At block 922 the method includes receiving, by one or more processors of a client device, an indication to access a note. The note includes user-generated note information and at least one context suggestion. The at least one context suggestion is based on one or more actions or events that occurred on the client device prior to creation of the note. At block 924 the method includes retrieving, by the one or more processors via a system-level user interface module, the note from memory. At block 926 the method includes identifying, by the one or more processors, whether to present the note via a note-taking application that is integrated as part of a system-level user interface of the client device, or another application executable by the client device. And at block 928, the method includes generating by the one or more processors via the system-level user interface module, a graphical representation of the note including the user-generated note information and the at least one context suggestion. The graphical representation is configured for presentation to a user of the client device

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising:
receiving, by one or more processors of a client device via a note-taking icon, presented on a shelf or system tray of the client device and associated with an operating system-level user interface module of the client device, an indication from a user of the client device to create a note via a note-taking application embedded in an operating system-level user interface of the client device, the operating system-level user interface module being associated with the note-taking application;
receiving, by the one or more processors via the operating system-level user interface module, user-generated note information;
identifying, by the one or more processors via the operating system-level user interface module, one or more actions or events that occurred on the client device when the indication to create the note was received;
generating, by the one or more processors via the operating system-level user interface module, one or more context suggestions for the note, the one or more context suggestions being based on the one or more actions or events;
creating, by the one or more processors via the operating system-level user interface module, the note including the user-generated note information and at least a given one of the one or more context suggestions; and
storing the note in memory associated with the client device.

2. The method of claim 1, further comprising the operating system-level user interface module presenting a visualization to the user with the one or more context suggestions.

3. The method of claim 1, wherein the note-taking icon associated with the operating system-level user interface module is associated with a note-taking application that is embedded in the operating system-level user interface of the client device.

4. The method of claim 1, wherein the indication to create the note is received based on selection of the note-taking icon presented in the shelf or system tray of the client device.

5. The method of claim 1, wherein generating the one or more context suggestions for the note includes generating a link to information about a meeting or an event that was occurring when the indication to create the note was received.

6. The method of claim 1, wherein generating the one or more context suggestions for the note includes generating contextual information about an action taken by the user within a predetermined amount of time prior to receiving the indication to create the note.

7. The method of claim 6, wherein the action taken comprises triggering the note while playing media content.

8. The method of claim 1, wherein the one or more actions or events includes determining that a focus of the user has transferred to the note from an application or a webpage.

9. The method of claim 1, further comprising presenting a set of note-taking options to the user.

10. The method of claim 1, further comprising:
upon receiving the indication, gathering by the one or more processors via the operating system-level user interface module, information about active applications or windows on the client device;
wherein generating the one or more context suggestions is further based on the information about active applications or windows on the client device.

11. The method of claim 10, further comprising creating bookmarks regarding a status of the active applications or windows on the client device.

12. The method of claim 1, wherein storing the note in memory comprises storing in memory corresponding to the operating system-level user interface module.

13. A computer-implemented method, comprising:
receiving, by one or more processors of a client device via a note-taking pod icon presented on a display of the client device, an indication to access a note, the note-taking pod icon providing a shortcut to one or more secondary operating system-level tasks or tools of the client device, and the note including user-generated note information and at least one context suggestion, in which the at least one context suggestion is based on one or more actions or events that occurred on the client device prior to creation of the note;
retrieving, by the one or more processors via an operating system-level user interface module associated with a note-taking application that is embedded in an operating system-level user interface of the client device, the note from memory;
identifying, by the one or more processors, whether to present the note via a note-taking application that is embedded in the operating system-level user interface, or another application executable by the client device; and
generating by the one or more processors via the operating system-level user interface module, a graphical representation of the note including the user-generated note information and the at least one context suggestion, the graphical representation being configured for presentation to a user of the client device.

14. The method of claim 13, wherein upon identification for presenting the note via the other application, the method further comprising sending note information including information about the at least one context suggestion to the other application.

15. The method of claim 13, wherein upon identification for presenting the note via the other application, the method further comprising transmitting note information including information about the at least one context suggestion to another client device associated with the user of the client device.

16. The method of claim 13, further comprising:
upon generating the graphical representation, receiving input for selection of the at least one context suggestion from the user of the client device;
accessing, by the one or more processors, information corresponding to the selection of the at least one context suggestion; and
presenting the information corresponding to the selection of the at least one context suggestion to the user.

17. A computing device, comprising:
memory configured to store system user interface information; and
one or more processors operatively coupled to the memory, the one or more processors being configured to:
receive, via a note-taking icon presented on a lock screen of the computing device and associated with an operating system-level user interface module of the computing device, an indication from a user of the computing device to create a note via a note-taking application embedded in an operating system-level user interface of the computing device, the operating system-level user interface module being associated with the note-taking application;
obtain, via the operating system-level user interface module, user-generated note information;
identify, via the operating system-level user interface module, one or more actions or events that occurred on the computing device when the indication to create the note was received;
generate, via the operating system-level user interface module, one or more context suggestions for the note, the one or more context suggestions being based on the one or more actions or events;
create, via the operating system-level user interface module, the note including the user-generated note information and at least a given one of the one or more context suggestions; and
store the note in the memory.

18. The computing device of claim 17, wherein the one or more processors are further configured, via the operating system-level user interface module, to either present a visualization to the user with the one or more context suggestions, or present a set of note-taking options to the user.

19. The computing device of claim 17, wherein generation of the one or more context suggestions for the note includes at least one of:
generation of a link to information about a meeting or an event that was occurring when the indication to create the note was received; or
generation of contextual information about an action taken by the user within a predetermined amount of time prior to receiving the indication to create the note.

20. A computing device, comprising:
memory configured to store system user interface information; and
one or more processors operatively coupled to the memory, the one or more processors being configured to:
receive, via a note-taking icon presented on a shelf or system tray of the computing device and associated with an operating system-level user interface module of the computing device, an indication to access a note, the note including user-generated note information and at least one context suggestion, in which the at least one context suggestion is based on one or more actions or events that occurred on the computing device prior to creation of the note, the operating system-level user interface module being associated with a note-taking application that is embedded in an operating system-level user interface of the computing device;
retrieve, via the operating system-level user interface module, the note from the memory;
identify whether to present the note via the note-taking application, or another application executable by the computing device; and
generate, via the operating system-level user interface module, a graphical representation of the note including the user-generated note information and the at least one context suggestion, the graphical representation being configured for presentation to a user of the computing device.
